(19) United States
(12) Patent Application Publication
(10) Pub. No.: US 2022/0073770 A1
(43) Pub. Date: Mar. 10, 2022

(54) NON-AQUEOUS INKJET INKS

(71) Applicant: Hewlett-Packard Development Company, L.P., Spring, TX (US)

(72) Inventor: Milton N. Jackson, Jr., Corvallis, OR (US)

(73) Assignee: Hewlett-Packard Development Company, L.P., Spring, TX (US)

(21) Appl. No.: 17/417,407

(22) PCT Filed: Mar. 20, 2019
(86) PCT No.: PCT/US2019/023205

§ 371 Date: Jun. 23, 2021

(51) Int. Cl. C09D 11/326; C09D 11/103; C09D 11/322; C09D 11/36; C09D 11/106; C09D 11/38

(52) U.S. Cl. CPC C09D 11/326; C09D 11/103; C09D 11/38; C09D 11/36; C09D 11/106; C09D 11/322

(57) ABSTRACT

An example of a non-aqueous inkjet ink includes a phenol-formaldehyde resin; a polyvinyl butyral resin; a pigment; a perfluoropolyether surfactant, a hydroxythioether surfactant, or a combination thereof; from about 2 wt % to about 10 wt % of a C₂ to C₆ ester solvent, based on a total weight of the non-aqueous inkjet ink; and a balance of a C₁ to C₅ alcohol solvent. The phenol-formaldehyde resin in the non-aqueous inkjet ink is a C₃ to C₈ alkyl-modified phenol-formaldehyde resin.

### BACKGROUND

In addition to home and office usage, inkjet technology has been expanded to high-speed, commercial and industrial printing. Inkjet printing is a non-impact printing method that utilizes electronic signals to control and direct droplets or a stream of ink to be deposited on media. Some commercial and industrial inkjet printers utilize fixed printheads and a moving substrate web in order to achieve high speed printing. Current inkjet printing technology involves forcing the ink drops through small nozzles by thermal ejection, piezoelectric pressure or oscillation onto the surface of the media. The technology has become a popular way of recording images on various media surfaces (e.g., plain paper, coated paper, etc.), for a number of reasons, including, low printer noise, capability of high-speed recording and multi-color recording.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram illustrating an example of a method for making an example of a non-aqueous inkjet ink disclosed herein;

FIG. 2 is a flow diagram illustrating examples of a printing method;

FIGS. 3A and 3B are black and white reproductions of portions of respective photographs of two different inks printed on untreated biaxially oriented polypropylene to illustrate a wetting effect of one of the resins of the resin package disclosed herein;

FIGS. 4A and 4B are black and white reproductions of portions of respective photographs of an example non-aqueous inkjet ink printed on untreated biaxially oriented polypropylene (FIG. 4A) and untreated low density polyethylene (FIG. 4B) and exposed to no rub test (top row), a rub test after 5 seconds of drying (middle row), and a rub test after 3 seconds of drying (bottom row);

FIG. 5 is a black and white reproduction of a portion of a photograph of an example non-aqueous inkjet ink printed on treated biaxially oriented polypropylene after a rub test; and

FIG. 6 is a graph depicting a print quality score (left Y-axis) and durability (in percent fade, right Y-axis) for non-aqueous inkjet inks including different amounts of polyvinyl butyral resin, where the inks are identified on the X-axis by the amount of polyvinyl butyral (in wt %) in the ink.

### DETAILED DESCRIPTION

Inkjet printing on non-porous polymeric substrates can present challenges due to the low surface energy of the substrate, and because these types of substrates tend to resist fluid penetration. The resistance to fluid penetration may be more prevalent when the non-porous polymeric substrate is untreated, i.e., has not been exposed to a surface treatment that renders the substrate more susceptible to ink adhesion. The term “untreated” indicates that a printing surface of a non-porous polymeric substrate has not been mechanically or chemically modified, such as by mechanical or chemical abrasion or by the application of a chemical ink receiving coating, for example. In some examples, the non-porous polymeric substrates can be materials, such as polyolefins, which lack functional groups that may otherwise aid in the adhesion of ink to the substrate.

Solvent-based inkjet inks have been shown to exhibit inconsistent durability, print quality (e.g., optical density <0.5), and dry times across different non-porous polymeric substrates. This may be due to variations in the substrate, ink coalescence, ink viscosity, ink dispersing agents, ink resin(s), and/or the ink vehicle.

Attempts have been made to improve ink performance, and in particular, to achieve more consistent print performance, on non-porous polymeric substrates by altering the ink formulation. One formulation includes a high concentration of resin and an aggressive solvent. While this formulation may provide improved ink adhesion on a variety of non-porous polymeric substrates, the high resin concentration can reduce decap performance and the aggressive solvent can degrade materials that are used to properly operate the inkjet architecture. Another formulation includes a resin and a tackifier. While this formulation may provide improved ink adhesion, the resin and tackifier combination may deleteriously affect print quality when attempting to perform printing continuously over an extended period without servicing the ejection device.

Examples of the inks disclosed herein are non-aqueous inkjet inks including specific amounts of each of an ester solvent and an alcohol solvent. It has been found that the solvent combination, when present in the ink in the specific amounts, significantly reduces dry times (e.g., to <3 seconds) on treated and untreated non-porous polymeric substrates. Reduced dry times enable quicker film formation on the surface of the non-porous polymeric substrate, which is particularly desirable in large scale commercial printing. Fast dry times can also lead to higher quality prints that have a desirable durability. Some examples of the ink formulation disclosed herein also include a specific combination of a phenol-formaldehyde resin and a polyvinyl butyral resin. It has been found that the resin combination, when present in the ink in the specific ratios (with respect to each other) and amounts (with respect to the total ink formulation) disclosed herein, significantly increases ink adhesion to both treated and untreated non-porous polymeric substrates. As shown in the examples provided herein, the solvent combination or the solvent and resin combinations contribute to desirable print attributes, such as rapid drying, durability (e.g., strong ink adhesion), and good optical density (e.g., ranging from about 0.8 to about 1) on a variety of non-porous polymeric media.

In addition to the non-aqueous inkjet inks, the examples disclosed herein relate to printing kits, methods of making, and printing methods. It is noted that when discussing the non-aqueous inkjet ink(s), the printing kit(s), the method(s) of making, and the printing method(s), these various discussions can be considered applicable to other examples whether or not they are explicitly discussed in the context of that example. Thus, for example, in discussing a solvent related to an example of the non-aqueous inkjet ink, such disclosure is also relevant to and directly supported in context of the printing kit(s), the method(s) of making, the printing method(s), vice versa, etc.

Throughout this disclosure, a weight percentage that is referred to as “wt % active(s)” refers to the loading of an active component of a dispersion, or other formulation that is present in the non-aqueous inkjet ink. For example, a pigment may be present in a solvent-based formulation (e.g., a stock solution) before being incorporated into the inkjet ink. In this example, the wt % actives of the pigment accounts for the loading (as a weight percent) of the pigment that is present in the inkjet ink, and does not account for the weight of the other components (e.g., dispersant, solvent, etc.) that are present in the formulation with the pigment. The term “wt %,” without the term active(s), refers to either i) the loading (in the non-aqueous inkjet ink) of a 100% active component that does not include other non-active components therein, or ii) the loading (in the non-aqueous inkjet ink) of a material or component that is used “as is” and thus the wt % accounts for both active and non-active components.

Non-Aqueous Inkjet Inks

In an example, the non-aqueous inkjet ink comprises or consists of a pigment; a perfluoropolyether surfactant, a hydroxythioether surfactant, or a combination thereof; from about 2 wt % to about 10 wt % of a C₂ to C₆ ester solvent, based on a total weight of the non-aqueous inkjet ink; and a balance of a C₁ to C₅ alcohol solvent. This example of the non-aqueous inkjet ink exhibits consistent printing performance, especially across different types of treated non-porous polymeric substrates. When the non-aqueous inkjet ink comprises these components, other suitable inkjet additives may be included, such as a non-ionic surfactant. When the non-aqueous inkjet ink consists of the listed components, the ink may include a small amount of water (e.g., 1 wt % or less) and polymeric dispersant that are introduced with the pigment, but does not include any other additives.

In another example, the non-aqueous inkjet ink comprises or consists of a phenol-formaldehyde resin, wherein the phenol-formaldehyde resin is a C₃ to C₈ alkyl-modified phenol-formaldehyde resin; a polyvinyl butyral resin; a pigment; a perfluoropolyether surfactant, a hydroxythioether surfactant, or a combination thereof; from about 2 wt % to about 10 wt % of a C₂ to C₆ ester solvent, based on a total weight of the non-aqueous inkjet ink; and a balance of a C₁ to C₅ alcohol solvent. These examples of the non-aqueous inkjet ink exhibit consistent printing performance, especially on different types of treated or untreated non-porous polymeric substrates. When the non-aqueous inkjet ink comprises these components, other suitable inkjet additives may be included, such as a non-ionic surfactant. When the non-aqueous inkjet ink consists of the listed components, the ink may include a small amount of water and polymeric dispersant that are introduced with the pigment, but does not include any other additives.

In still another example, the non-aqueous inkjet ink, consists of a non-self-dispersed pigment; a polymeric dispersant; from about 0.25 wt % to about 0.35 wt % of a perfluoropolyether surfactant, a hydroxythioether surfactant, or a combination thereof, based on a total weight of the non-aqueous inkjet ink; from about 2 wt % to about 10 wt % of a C₂ to C₆ ester solvent, based on the total weight of the non-aqueous inkjet ink; water in an amount less than 1 wt %; and a balance of a C₁ to C₅ alcohol solvent; and an optional resin package consisting of a C₃ to C₈ alkyl-modified phenol-formaldehyde resin and a polyvinyl butyral resin.

Solvent Package

The solvent package in the non-aqueous inkjet inks disclosed herein includes an alcohol solvent and an ester solvent. More specifically, the solvent package includes a C₁ to C₅ alcohol solvent and a C₂ to C₆ ester solvent. In some instances, the surfactants may also be considered as part of the solvent package. Suitable surfactants are discussed in more detail herein.

The alcohol solvent serves as the main or primary solvent vehicle component, making up 70 wt % or more of the total weight of the non-aqueous inkjet ink. Thus, the “non-aqueous inkjet inks” of the present disclosure can be likewise referred to as “alcohol-based inkjet inks.” It should be noted that the term “non-aqueous” indicates that the ink compositions do not include water for purposes of providing a solvent vehicle for the non-aqueous inkjet ink as a whole. If some small amount of water is included in the non-aqueous inkjet inks of the present disclosure, such as may be the case when brought in with another component, e.g., a pigment dispersion, added surfactant or other additive(s) or component(s), then such inkjet inks are still considered to be “non-aqueous.” For further clarity, if less than about 1 wt %, or more typically, less than about 0.75% or even less than about 0.5 wt %, of water is present, the ink composition is still considered to be a “non-aqueous inkjet ink.”

The alcohol solvent can include a C₁ to C₅ alcohol. These alcohols can be selected from the group consisting of methanol, ethanol, n-propanol, isopropanol, cyclopropanol, butanol, n-butanol, 2-butanol, isobutanol, tert-butanol, cyclobutanol, pentanol, cyclopentanol, and a combination thereof. The C₁ to C₅ alcohol solvents used herein, for example, can be less aggressive than other types of solvents and may not degrade materials often found in inkjet architecture. The C₁ to C₅ alcohols can also improve dry time and provide enhanced solubility of various components. In some examples, the alcohol solvent can be denatured. In one example, the C₁ to C₅ alcohol solvent is ethanol denatured with tert-butanol and denatonium benzoate. In other examples, the alcohol solvent can be a straight chain alcohol. In still other examples, the alcohol solvent can be branched, e.g., isopropanol or one of the branched butanols. In one example, the alcohol solvent can include ethanol. In yet another example, the alcohol solvent can include n-propanol.

The alcohol solvent can be present in the ink formulation in an amount ranging from about 70 wt % to about 97 wt %, or from about 75 wt % to about 85 wt %, or from about 80 wt % to about 90 wt %, or from about 70 wt % to about 80 wt %, or from about 90 wt % to about 97 wt % each of which is based on a total weight of the non-aqueous inkjet ink.

The ester solvent is a C₂ to C₆ ester solvent. In an example, the ester solvent is methyl acetate, ethyl acetate or another ester solvent that readily dissolves and/or emulsifies the surfactant(s). By improving surfactant dissolution and/or emulsification, the C₂ to C₆ ester solvent improves the decap performance of the ink.

In addition to helping to dissolve and/or emulsify the surfactant(s), it has been found that the ester solvent, when used in combination with the alcohol solvent in the respective amounts set forth herein, contributes to relatively consistent print performance across a wide variety of non-porous polymeric media. In other words, the inks disclosed herein, which include from about 2 wt % to about 10 wt % of the ester solvent and from about 70 wt % to about 97 wt % of the alcohol solvent, exhibit little performance variability across treated and untreated non-porous polymeric media. When the ester solvent is present in the ink in an amount less than 2 wt %, it has been found that the readability of printed barcodes degrades and/or that the edge roughness of printed lines increases. Alternatively, when the ester solvent is present in the ink in an amount greater than 10 wt %, it has been found that the durability of the print degrades. In some examples, the C₂ to C₆ ester solvent can be present in the ink formulation in an amount ranging from greater than 2 wt % to less than 8 wt %. In other examples, the C₂ to C₆ ester solvent can be present in the ink formulation in an amount ranging from greater than 2 wt % to less than or equal to 6 wt %. In still other examples, the C₂ to C₆ ester solvent can be present in the ink formulation in an amount ranging from about 2.5 wt % to about 5 wt %.

The combination of the C₂ to C₆ ester solvent and the C₁ to C₅ alcohol also contributes to the ink having exceptional dry time (<3 seconds) may be achieved on non-porous polymeric media.

It is to be understood that any of the ester and alcohol solvents disclosed herein may be used in combination in the non-aqueous inkjet ink. In one example, the C₂ to C₆ ester solvent is ethyl acetate, and the C₁ to C₅ alcohol solvent is ethanol denatured with tert-butanol and denatonium benzoate.

Surfactant

The surfactant(s) in the non-aqueous inkjet ink are selected from the group consisting of a perfluoropolyether surfactant, a hydroxythioether surfactant, or a combination thereof. The surfactant(s) may be considered to be part of the solvent package.

Perfluoropolyethers can have a positive impact on decap performance and can also reduce ink puddling when dispensing the solvent-based inks that are described herein. In one specific example, the perfluoropolyether can be a dialkyl amide perfluoropolyether, e.g., a perfluoropolyether backbone with ends functionalized with an alkyl amide group. A commercially available example of a dialkyl amide perfluoropolyether is FLUOROLINK® A10 or A10P (the pelletized version of A10), which is polyperfluoroethoxymethoxy difluoromethyl distearamide available from Solvay (Belgium). As mentioned herein, perfluoropolyethers can benefit from the presence of the C₂ to C₆ ester solvent, which dissolves and/or emulsifies the perfluoropolyether without further processing. The perfluoropolyether can be admixed/dissolved in the C₂ to C₆ ester solvent prior to admixing with the alcohol solvent, or it can be admixed after the alcohol solvent is present.

One example one example of the perfluoropolyether is a dialkyl amide perfluoropolyether, which may have a number-average molecular weight within the range from about 400 Daltons to about 4,000 Daltons. One example structural formula can be represented as Formula I, as follows:

—CF₂—(O—CF₂—CF₂)ₙ—(O—CF₂)ₘ—O—CF₂—X Formula I

where X can be —CONH—(C₉ to C₃₂ alkyl), e.g., C₁₈H₃₇, n can be from 1 to 53, and m can be from 31 to 1, for example. The C₉ to C₃₂ alkyl group can be different for the X on individual ends of the polymer. Furthermore, the C₉ to C₃₂ alkyl can be straight-chained or branched. In some examples, shorter or longer dialkyl amide perfluoropolyether chains can be used, but in more specific examples, m and n can be such that the number-average molecular weight can be from about 1,200 Daltons to about 2,300 Daltons, or from about 1,200 Daltons to about 2,000 Daltons, or from about 2,000 Daltons to about 2,500 Daltons, or from about 2,100 Daltons to about 2,300 Daltons, etc.

The hydroxythioether surfactant may also be referred to as a hydroxyl thioether. The hydroxythioether structure is R′—S—ROH, where R and R′ are independently selected from an alkyl chain and an aromatic group. While the OH group is shown attached to the R group, it is to be understood that the OH group may be attached to either the R or R′ group or both of the R and R′ group. A commercially available example of a hydroxythioether surfactant is DYNOL™ 360, available from Evonik Ind.

The perfluoropolyether surfactant or the hydroxythioether surfactant may be used alone or in combination in the non-aqueous inkjet ink. Whether used alone or in combination, the total amount of the perfluoropolyether surfactant and/or the hydroxythioether surfactant ranges from about 0.25 wt % to about 0.35 wt %. When the surfactant(s) is/are included in an amount greater than 0.35 wt %, the dry time becomes longer, and when the surfactant(s) is/are included in an amount less than 0.25 wt %, the decap performance degrades.

Pigment

The non-aqueous inkjet inks disclosed herein are pigment-based inks. Because the inks are pigmented, no dye is included in the ink.

The pigment can be any of a number of primary or secondary colors, or black or white. As specific examples, the pigment may be any color, including, as examples, a cyan pigment, a magenta pigment, a yellow pigment, a black pigment, a violet pigment, a green pigment, a brown pigment, an orange pigment, a purple pigment, a white pigment, or combinations thereof.

The pigment may be incorporated into the non-aqueous inkjet ink as a pigment dispersion. The pigment dispersion may include the non-self-dispersed pigment; a polymeric dispersant; and one or more co-solvents that are compatible with the solvent package of the non-aqueous inkjet ink.

The non-self-dispersed pigment is not self-dispersing.

Examples of non-self-dispersed blue or cyan organic pigments include C.I. Pigment Blue 1, C.I. Pigment Blue 2, C.I. Pigment Blue 3, C.I. Pigment Blue 15, Pigment Blue 15:3, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Examples of non-self-dispersed magenta, red, or violet organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Red 286, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50. Any quinacridone pigment or a co-crystal of quinacridone pigments may be used for magenta inks.

Examples of non-self-dispersed yellow organic pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 77, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 122, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 155, C.I. Pigment Yellow 167, C.I. Pigment Yellow 172, C.I. Pigment Yellow 180, C.I. Pigment Yellow 185, and C.I. Pigment Yellow 213.

Carbon black is a suitable non-self-dispersed inorganic black pigment. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, BLACK PEARLS® series, the MOGUL® series, or the MONARCH® series manufactured by Cabot Corporation, Boston, Mass., (such as, e.g., REGAL® 400R, REGAL® 330R, REGAL® 660R, BLACK PEARLS® 700, BLACK PEARLS® 800, BLACK PEARLS® 880, BLACK PEARLS® 1100, BLACK PEARLS® 4350, BLACK PEARLS® 4750, MOGUL® E, MOGUL® L, and ELFTEX® 410); and various black pigments manufactured by Evonik Degussa Orion Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® 75, PRINTEX® 80, PRINTEX® 85, PRINTEX® 90, PRINTEX® U, PRINTEX® V, PRINTEX® 140U, Special Black 5, Special Black 4A, and Special Black 4). An example of an organic black pigment includes aniline black, such as C.I. Pigment Black 1.

Examples of non-self-dispersed green pigments include C.I. Pigment Green 1, C.I. Pigment Green 2, C.I. Pigment Green 4, C.I. Pigment Green 7, C.I. Pigment Green 8, C.I. Pigment Green 10, C.I. Pigment Green 36, and C.I. Pigment Green 45.

Examples of non-self-dispersed brown organic pigments include C.I. Pigment Brown 1, C.I. Pigment Brown 5, C.I. Pigment Brown 22, C.I. Pigment Brown 23, C.I. Pigment Brown 25, C.I. Pigment Brown 41, and C.I. Pigment Brown 42.

Examples of non-self-dispersed orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, C.I. Pigment Orange 64, C.I. Pigment Orange 66, C.I. Pigment Orange 71, and C.I. Pigment Orange 73.

The average particle size of the pigments may range anywhere from about 20 nm to less than 175 nm. In an example, the average particle size ranges from about 70 nm to about 150 nm. Smaller pigment particles may be desirable to improve ink stability. The pigment particle size may be determined using a NANOTRAC® Wave device, from Microtrac, e.g., NANOTRAC® Wave II or NANOTRAC® 150, etc., which measures particles size using dynamic light scattering (DLS). Average particle size can be determined using particle size distribution data generated by the NANOTRAC® Wave or another suitable DLS device.

Any of the pigments mentioned herein can be dispersed by a separate dispersant, such as polyvinyl butyral.

The balance of the pigment dispersion may be any alcohol solvent that is compatible with the ink solvent package. In an example, pigment dispersions including a C₁ to C₅ alcohol solvent have been found to be particularly stable when included in the solvent package disclosed herein. Any of the C₁ to C₅ alcohol solvents disclosed herein may be used in the pigment dispersion.

In the pigment dispersion, the pigment may be present in an amount of about 10 wt % (based on a total weight of the pigment dispersion), the dispersant may be present in an amount ranging from about 8 wt % to about to about 10 wt % (based on a total weight of the pigment dispersion), and the balance may be the C₁ to C₅ solvent.

Enough of the pigment dispersion is added to the solvent package so that the non-aqueous inkjet ink includes up to 4 wt % of the pigment solids and up to 4 wt % of the dispersant solids.

It is to be understood that the liquid components of the pigment dispersion become part of the liquid vehicle in the inkjet ink.

Resin Package

The resin package in some examples of the non-aqueous inkjet ink includes both a phenol-formaldehyde resin and a polyvinyl butyral resin.

The term “phenol-formaldehyde resin” refers generally to a genus or series of resins that includes alternating moieties of various phenols (modified or unmodified) and methylene (—CH₂— provided by the formaldehyde) groups, e.g., phenol-methylene-phenol-methylene, etc. One specific type of phenol-formaldehyde resin is a novolac resin that starts and ends the polymer chain with a phenol moiety (thus consuming the formaldehyde during polymerization and often leaving excess unreacted phenols in the reaction mixture). Phenol-formaldehyde resins can be linked together at the ortho position or the para position relative to the hydroxyl group positioned on the aromatic ring. In the examples disclosed herein, the phenol group of the phenol-formaldehyde resin is modified, e.g., with a C₃ to C₈ alkyl group, at the ortho or para position.

As mentioned, the phenol-formaldehyde resin can be a novolac resin. Novolac resins can be prepared without excess of formaldehyde so that formaldehyde is consumed during the polymerization process. Because the phenol groups react with the formaldehyde groups (typically) at the para- or ortho-position, and do not react with other phenol groups, the polymer formed includes alternating phenol-containing units (from the phenol group) and —CH₂— units (from the formaldehyde). As all of the formaldehyde groups are consumed, the end units of the polymer can both be provided by the phenol-containing group, e.g., phenol-CH₂-phenol-CH₂-phenol-CH₂-phenol, etc. In other words, the polymer begins and ends with phenol moieties. Thus, in one example, the phenol-formaldehyde resin can have a formaldehyde to phenol molar ratio of less than one. As the formaldehyde is used up during the formation of the phenol-formaldehyde resin, there is no excess formaldehyde present in the inkjet ink. The lack of excess formaldehyde can prevent the novolac resin from curing in the inkjet ink.

The molecular weight of the phenol-formaldehyde resin(s) disclosed herein can vary depending upon the chain length. With the alkyl-modified phenol-formaldehyde resin(s) disclosed herein, the molecular weight can also be increased per unit or “mer” along the polymer chain, due to other side groups (e.g., alkyls) that are positioned on the aromatic ring of the phenol in addition to the hydroxyl group. In some examples, the phenol-formaldehyde resin can have a weight average molecular weight ranging from about 1,000 to about 10,000, from about 1,000 to about 5,000, from about 1,000 to about 2,600, or from about 1,800 to about 2,600. The units of molecular weight throughout this disclosure are g/mol or Daltons.

In specific examples, the phenol-formaldehyde resin can have a softening point temperature within the range of from about 135° C. to about 180° C., or from about 135° C. to about 160° C., or from about 140° C. to about 170° C. “Softening point” or “softening temperature” of polymers described herein can be determined using the American Society for Testing and Materials (ASTM) protocol E28-14, sometimes referred to as the “ring and ball test.” Ring and ball testing occurs by bringing the material above the softening point and stirring until melted, e.g., 75° C. to 100° C. above the expected softening point. Two brass rings are heated to molten temperature and placed on a metal plate coated with dextrin and glycerin. The material is then placed on the rings, cooled for 30 minutes, and excess material is removed above the brass rings. The rings (with the material thereon) are bathed in water that extends 2 inches above the brass rings (starting at 5° C.). As the bath is warmed and stirred at a uniform rate, the material softens on the rings and two respective steel balls are placed on the polymer through the polymer material within the opening of the rings. The softening point is established by averaging the two temperatures recorded when the individual balls contact the metal plate. While example softening points are provided, it is to be understood that phenol-formaldehyde resins exhibiting a softening point outside of the given ranges can also be used.

In the examples disclosed herein, the phenol-formaldehyde resin is an alkyl-modified phenol-formaldehyde resin, where the alkyl ranges from a 3 carbon alkyl (C₃, propyl) to an 8 carbon alkyl (C₈, octyl). The C₃ to C₈ alkyl group can be straight chained or branched. It is noted that the phenol moiety can be modified with groups other than C₃ to C₈ alkyl groups, such as, for example, alicyclic groups, oxygen-modified side groups, nitrogen-modified side groups, sulfur-modified side groups, etc. Examples of an alkyl-modified phenol-formaldehyde resin suitable for the phenol-formaldehyde resin include butylphenol formaldehyde polymers, having a weight average molecular weight ranging from about 1,800 to 2,600 and a softening point from about 140° C. to about 150° C. The butylphenol formaldehyde can be, for example, a tert-butylphenol formaldehyde polymer (a.k.a., t-butylphenol-formaldehyde resin), such as para-tert-butylphenol formaldehyde in one example. That being stated, the C₃ to C₈ alkylphenol formaldehyde may include an alkylphenol that is ortho (o-) or para (p-) relative to the hydroxyl group. If para, the formaldehyde polymerization can occur at the ortho position. For example, the C₃ to C₈ alkyl group can be at the para-position and can be branched, e.g., para-tert-butylphenol-formaldehyde, and the polymerization can occur at the ortho position (both ortho positions occupied for polymerization except for at the end units where only one position may be occupied). If ortho, the formaldehyde polymerization can occur at either the other ortho position or at the para position. In one example, the phenol-formaldehyde resin is a t-butylphenol-formaldehyde resin. An example of a commercially available 4-t-butylphenol-formaldehyde resin that can be used as the phenol-formaldehyde resin in the inkjet inks disclosed herein is REACTOL™ 1111E (from Lawter, Inc.), which is non-reactive and highly soluble in C₁-C₄ acetates, e.g., >10% solubility in ethyl actetate.

The phenol-formaldehyde resin may lead to improved ink adhesion on non-porous polymeric substrates. For example, the aromatic phenol moieties may be able to interact with the C—H bonds of, e.g., polypropylene substrates, which can contribute to the improved adhesion of the ink to these substrates. Moreover, the phenol-formaldehyde resin does not result in kogation (build-up of ink solids on a thermal inkjet printhead) and thus the inks disclosed herein do not include an additional anti-kogation agent.

The polyvinyl butyral (PVB) resin is:

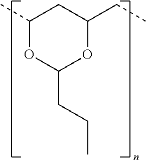

where n ranges from 70 to 120 so that the weight average molecular weight of the PVB is less than 20,000. It is to be understood that any PVB that is added as part of the resin package is in addition to any PVB dispersant that may be included in the ink as part of the pigment dispersion.

When the resin package is included in the non-aqueous inkjet ink, a ratio of the polyvinyl butyral resin to the phenol-formaldehyde resin ranges from 1:10 to 1:1.5; and a combined total of the polyvinyl butyral resin and the phenol-formaldehyde resin in the non-aqueous inkjet ink ranges from about 2 wt % active to about 3 wt % active, based on a total weight of the non-aqueous inkjet ink. In one example, the ratio of polyvinyl butyral resin to the phenol-formaldehyde resin is 1:4. In one example, the polyvinyl butyral resin is present in an amount of about 0.1 wt % active up to 1.0 wt % active (based on the total weight of the ink, and not including any PVB that may be present from the pigment dispersion), and the phenol-formaldehyde resin is present in an amount ranging from about 0.5 wt % active up to 2.5 wt % active (based on the total weight of the ink). In this example, the combined total of the polyvinyl butyral resin and the phenol-formaldehyde resin in the non-aqueous inkjet ink ranges from about 2 wt % active to about 3 wt % active.

Other Additives

As illustrated in the Example section, examples of the non-aqueous inkjet ink compositions disclosed herein achieve desirable surface wetting, dry times, durability, and print quality. As such, in some examples of the inkjet ink, additional additive(s) are not included. It is to be understood, however, that a non-ionic surfactant may be desirable in some instances, as these surfactants can contribute to improved print performance (e.g., decap, etc.).

Examples of suitable non-ionic surfactants include a secondary alcohol ethoxylate, such as TERGITOL™ 15-S-7, or a nonylphenol ethoxylate, such as TERGITOL™ NP9 (from Dow Chemical); non-ionic acetylenic surfactants, such as SURFYNOL® 465, 420, 485 (from Evonik Ind.); polyoxyethylene sorbitan monostearate, such as TWEEN™ 60 (from Croda Inc.); organosilicones, such as SILWET® L7622 (from Ribelin); and/or combinations thereof.

In an example, the non-aqueous inkjet inks can include from about 0.1 wt % active to about 2 wt % active of the non-ionic surfactant, based on a total weight of the non-aqueous inkjet ink. In other examples, the non-ionic surfactant may be present in amounts ranging from about 0.1 wt % active to about 1.5 wt % active, or from about 0.25 wt % active to about 1 wt % active, each of which is based on a total weight of the non-aqueous inkjet ink.

The non-aqueous inkjet ink may or may not include other inkjet additives. As one example, an antimicrobial may not be included, in part because the alcohol solvent helps to inhibit microbial growth.

Method of Making

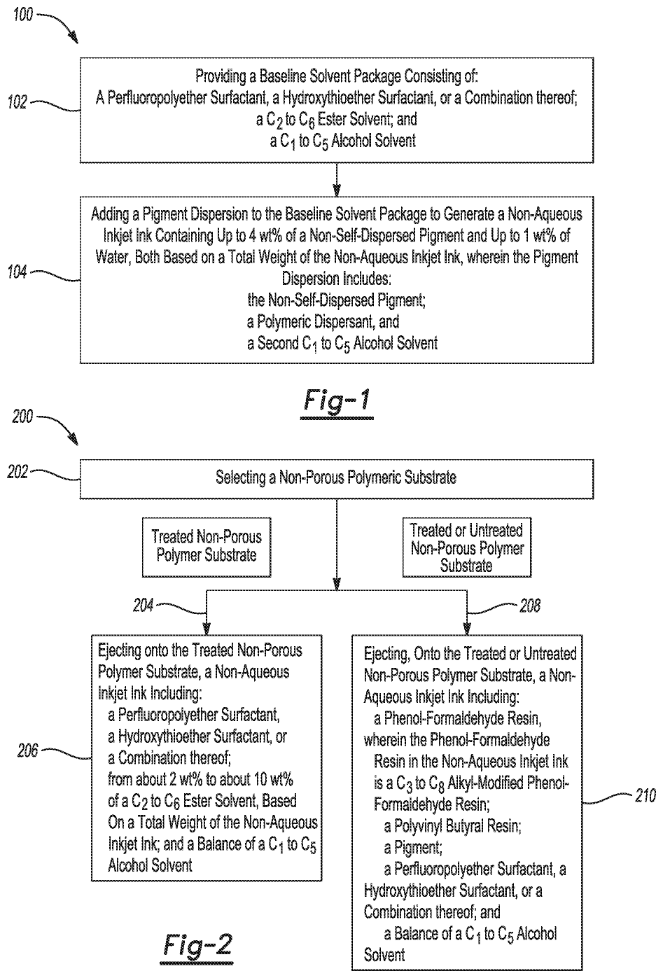

A method of making an example of the non-aqueous inkjet ink is shown in FIG. 1. As depicted, the method 100 includes providing a baseline solvent package consisting of a perfluoropolyether surfactant, a hydroxythioether surfactant, or a combination thereof; a C₂ to C₆ ester solvent; and a C₁ to C₅ alcohol solvent (as shown at reference numeral 102); and adding a pigment dispersion to the baseline solvent package to generate a non-aqueous inkjet ink containing up to 4 wt % of a non-self-dispersed pigment and up to 1 wt % of water, both based on a total weight of the non-aqueous inkjet ink, wherein the pigment dispersion includes the non-self-dispersed pigment; a polymeric dispersant; and a second C₁ to C₅ alcohol solvent (as shown at reference numeral 104).

The baseline solvent package includes any example of the perfluoropolyether surfactant and/or the hydroxythioether surfactant, and any example of the C₂ to C₆ ester solvent; and any example of the C₁ to C₅ alcohol solvent disclosed herein. The pigment dispersion includes any examples of the non-self-dispersed pigment, any example of the polymeric dispersant, and any example of the second C₁ to C₅ alcohol solvent disclosed herein. The amount of each component in the baseline solvent package may be adjusted so that after the pigment dispersion is added, the final weight percentages of the surfactant(s), the C₂ to C₆ ester solvent; and the C₁ to C₅ alcohol solvent are within the ranges provided herein for examples of the non-aqueous inkjet inks. For example, the final ink may include from about 0.25 wt % to about 0.35 wt % of the perfluoropolyether surfactant, the hydroxythioether surfactant, or the combination thereof, based on the total weight of the non-aqueous inkjet ink; and from about 2 wt % to about 10 wt % of a C₂ to C₆ ester solvent, based on the total weight of the non-aqueous inkjet ink.

The amount of the pigment dispersion that is added to the baseline solvent package is sufficient to render up to 4 wt % of the solid pigment. The amount of the polymeric dispersant and the second C₁ to C₅ alcohol solvent that are present in the final ink will depend upon how much of these components are present in the pigment dispersion and how much of the pigment dispersion is added to the baseline solvent package.

Some examples of the method also include adding a resin package to the baseline solvent package, the resin package consisting of a C₃ to C₈ alkyl-modified phenol-formaldehyde resin and a polyvinyl butyral resin. The amount of each resin is within the ranges provided herein.

Printing Kits

Any example of the non-aqueous inkjet inks disclosed herein may be included in a printing kit with a suitable substrate (print medium, recording medium, etc.). In an example, the printing kit comprises: a treated non-porous polymeric substrate; and a non-aqueous inkjet ink comprising or consisting of a pigment; a perfluoropolyether surfactant, a hydroxythioether surfactant, or a combination thereof; from about 2 wt % to about 10 wt % of a C₂ to C₆ ester solvent, based on a total weight of the non-aqueous inkjet ink; and a balance of a C₁ to C₅ alcohol solvent.

In another example, the printing kit comprises: a treated or untreated non-porous polymeric substrate; and a non-aqueous inkjet ink comprising or consisting of a phenol-formaldehyde resin, wherein the phenol-formaldehyde resin is a C₃ to C₈ alkyl-modified phenol-formaldehyde resin; a polyvinyl butyral resin; a pigment; a perfluoropolyether surfactant, a hydroxythioether surfactant, or a combination thereof; from about 2 wt % to about 10 wt % of a C₂ to C₆ ester solvent, based on a total weight of the non-aqueous inkjet ink; and a balance of a C₁ to C₅ alcohol solvent.

While these are two examples, it is to be understood that any example of the ink disclosed herein may be included in a printing kit with any example of the treated or untreated non-porous polymeric substrates disclosed herein.

With regard to the non-porous polymeric substrate, the term “non-porous” does not infer that the substrate is devoid of any and all pores in every case, but rather indicates that the substrate does not permit bulk transport of a fluid through the substrate. In some examples, a non-porous substrate can permit very little water absorption, at or below 0.1 vol %. In yet another example, a non-porous substrate can allow for gas permeability. In another example, however, a non-porous substrate can be substantially devoid of pores.

In some examples of the printing kit, the non-porous polymeric substrate is treated, or exposed to a surface treatment that renders the substrate more susceptible to ink adhesion. Examples of treated non-porous polymeric substrates include treated biaxially oriented polypropylene or other polyolefin, treated low density polyethylene (density less than 0.93 g/cm³), and treated high density polyethylene (density from 0.93 g/cm³ to 0.97 g/cm³).

In some examples of the printing kit, the non-porous polymeric substrate is untreated, which as noted herein, refers to both a lack of any chemical treatment, etching, coating, etc., as well as a lack of any specific mechanical treatment to modify the surface thereof, such as patterning, roughening, etc., in order to make the non-porous polymeric substrate more receptive to the inkjet inks. Furthermore, when referring to untreated substrates, this can also include non-porous polymeric substrates that can lack functional groups at a print surface that can aid in adhesion of ink to the substrate. In some examples, the untreated materials can be unmodified chemically and/or mechanically at the surface of the substrate as well as unmodified along the polymer chain of the material.

Examples of uncoated or untreated polymeric substrate may include a polyolefin, such as a polyethylene or a polypropylene. In another example, the non-porous polymeric substrate can be a biaxially oriented polyolefin, such as a biaxially oriented polypropylene or other polyolefin. In an example, the non-porous polymeric substrate is untreated biaxially oriented polypropylene. As used herein, a “biaxially-oriented” substrate refers to a substrate that has a stretched crystal or structural orientation in at least two directions or axes. This process can generate non-porous polymeric films that can have a higher tensile strength (per given thickness), greater stiffness, enhanced fluid barrier, etc. Biaxially-oriented substrates can have less permeability and can thereby limit diffusion compared to other types of substrates. Because these substrates tend to have enhanced fluid barrier properties, printing on biaxially-oriented substrates can be particularly challenging in some examples. The example non-aqueous inkjet inks disclosed herein have been found to be particularly suitable for biaxially-oriented substrates.

Some other examples of untreated non-porous polymeric substrates include polyvinyl chloride, low density polyethylene (density less than 0.93 g/cm³), high density polyethylene (density from 0.93 g/cm³ to 0.97 g/cm³), polyethylene terephthalate, polystyrene, polylactic acid, polytetrafluoroethylene (e.g., TEFLON® from the Chemours Company), or blends thereof, or blends of any of these with a polyolefin.

Non-porous substrates can be continuous non-fibrous structures.

In some examples, the non-porous polymeric substrate can also have low surface energy. In an example, the non-porous polymeric substrate is untreated and has a surface energy from about 18 mN/m to about 35 mN/m. In yet other examples, the substrate can have a surface energy ranging from about 20 mN/m to about 30 mN/m or from about 25 mN/m to about 35 mN/m. When untreated, in particular, the lack of functional groups along the polymer, the lack of surface modification of the substrate, and the low surface energy of the print surface can make this type of substrate difficult to print upon, as most ink compositions do not adhere well thereon. However, as shown in the Example section, the non-aqueous inkjet inks disclosed herein have been found to be particularly suitable for these types of non-porous polymeric substrates.

“Surface energy” can be evaluated and quantified using contact angle measurement (goniometry) of a liquid applied to the surface of the polymer. The device used for taking the static contact angle measurement can be an FTA200HP or an FTA200, from First Ten Angstroms, Inc. For example, Young's equation (γ=yₛₗ+γₗᵥ cos θ; where θ is the contact angle, γ is the solid surface free energy, γₛₗ is the solid/liquid interfacial free energy, and γₗᵥ is the liquid surface free energy) can be used to calculate the surface energy from measured contact angle using a dyne fluid, e.g., water. However, in some instances where water is not a good dyne fluid for a particular test, other fluids, such as methylene iodide, ethylene glycol, formamide, etc., can be used to probe the surface generally or to probe different types of surface energy components while avoiding fluids that may dissolve or absorb into the surface. With polymer or non-porous substrates of the present disclosure, the dyne fluid selection generally provides very similar results that may be averaged to the extent there is some degree of different data. In addition to these considerations, dyne fluids can be selected which have known surface tension properties in a controlled atmosphere. In other words, by using dyne fluid(s) (liquid) and atmosphere (gas) with known free energies, and by measuring the contact angle (acute angle between the flat surface and the relative angle at the base of liquid where it contacts the flat surface) of the liquid bead on the polymer surface, these three pieces of data can be used with Young's equation to determine the surface energy of the polymer surface.

Printing Methods

Examples of the printing method 200 are shown in FIG. 2. The printing method 200 includes selecting a non-porous polymeric substrate, as shown at reference numeral 202. Any example of the non-aqueous inkjet ink disclosed herein may then be jetted onto the selecting non-porous polymeric substrate using a thermal inkjet printer or a piezoelectric inkjet printer.

One specific example of the method is shown at reference numerals 202, 204 and 206. In this example, the selected non-porous polymeric substrate is a treated non-porous polymeric substrate (reference numeral 204), and the method further includes ejecting, onto the treated non-porous polymeric substrate, a non-aqueous inkjet ink including a perfluoropolyether surfactant, a hydroxyl thio-ether surfactant, combination thereof; from about 2 wt % to about 10 wt % of a C₂ to C₆ ester solvent, based on a total weight of the non-aqueous inkjet ink; and a balance of a C₁ to C₅ alcohol solvent (reference numeral 206).

Another specific example of the method is shown at reference numerals 202, 208 and 210. In this example, the selected non-porous polymeric substrate is a treated or untreated non-porous polymeric substrate (reference numeral 208), and the method further includes ejecting, onto the treated or untreated non-porous polymeric substrate, a non-aqueous inkjet ink including a phenol-formaldehyde resin, wherein the phenol-formaldehyde resin in the non-aqueous inkjet ink is a C₃ to C₈ alkyl-modified phenol-formaldehyde resin; a polyvinyl butyral resin; a pigment; a perfluoropolyether surfactant, a hydroxythioether surfactant, or a combination thereof; and a balance of a C₁ to C₅ alcohol solvent (reference numeral 210). The resin combination in this example ink renders the ink particularly suitable for both treated and untreated polymeric substrates.

Ejecting may involve dispensing the respective non-aqueous inkjet ink from a thermal inkjet printer or a piezoelectric inkjet printer. With thermal inkjet printing, momentary temperatures at fluidic surfaces at the thermal inkjet resistor can get to about 500° C. or more in some instances. It has been found that inks including the resin combination disclosed herein are not deleteriously affected at these temperatures, and thus do not negatively affect decap performance or result in an early onset of kogation. As such, the inkjet inks may be suitable for use in thermal inkjet printing. That stated, with piezo inkjet printheads, ink firing is not temperature dependent and this type of kogation may not occur; therefore, the example inks can also work well with piezo-actuated inkjet printheads

While two example printing methods 200 are shown, it is to be understood that any example of the non-aqueous inkjet inks and the non-porous polymeric substrates disclosed herein may be used in an inkjet printing method.

To further illustrate the present disclosure, examples are given herein. It is to be understood that these examples are provided for illustrative purposes and are not to be construed as limiting the scope of the present disclosure.

### EXAMPLES

### Example 1

Two non-aqueous inkjet inks were prepared. Both of the inks included a black pigment dispersion. The black pigment dispersion included about 10 wt % carbon black pigment, from about 8 wt % to about 10 wt % of polyvinyl butyral as a separate dispersant, and a balance of ethanol denatured with tert-butyl alcohol and denatonium benzoate (SDA 40B). The black pigment had an average diameter of 100 nm. The first ink included additional polyvinyl butyral (having a weight-average molecular weight less than 20,000 Daltons). The second ink did not include any additional polyvinyl butyral beyond what was introduced as part of the pigment dispersion.

The general formulation of each of the inks is shown in Table 1, with the wt % active of each component that was used. As such, the wt % for the pigment represents the solid pigment loading, and does not account for other components of the pigment dispersion.

TABLE 1

| | | First | Second |
|---|---|---|---|
| Ingredient | Specific Component | Ink | Ink |
| Pigment dispersion | Black pigment dispersion | 2 | 2 |
| Resin | Polyvinyl butyral | 0.25 | 0.50 |
| Surfactant | FLUOROLINK ® A10P | 0.3 | 0.3 |
| Co-solvent | Ethyl acetate | 5 | 5 |
| Solvent | Ethanol denatured with | Balance | Balance |
| | tert-butanol and | | |
| | denatonium benzoate | | |

Prints were generated using each of the inks. To generate the prints, the inks were thermal inkjet printed on untreated biaxially-oriented polypropylene.

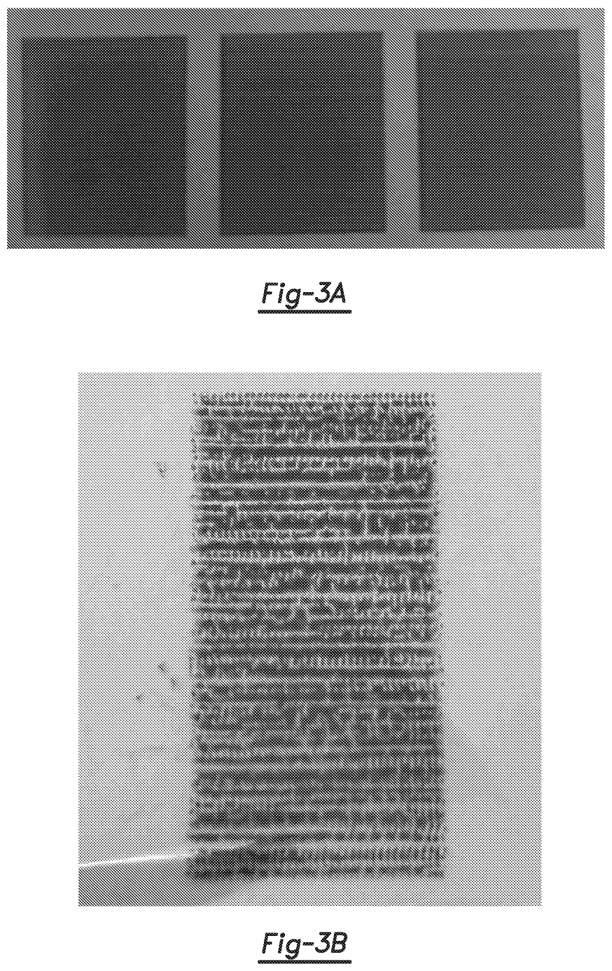

The prints are shown (in black and white) in FIGS. 3A and 3B. The prints generated with the first ink are shown in FIG. 3A; and the print generated with the second ink is shown in FIG. 3B.

As shown in FIGS. 3A and 3B, the first ink, including the additional polyvinyl butryal resin, was better able to wet untreated biaxially-oriented polypropylene than the second ink, which did not include additional resin beyond the polymeric dispersant of the pigment dispersion. This example illustrates that the addition of a resin can improve the wetting of the non-aqueous ink on untreated non-porous polymeric substrates. It is believed that both of these inks may exhibit suitable wetting and other print attributes when printed on treated non-porous polymeric substrates.

### Example 2

An example of the non-aqueous inkjet ink disclosed herein was prepared. Example ink A included a black pigment dispersion including about 10 wt % carbon black pigment, from about 8 wt % to about 10 wt % polyvinyl butyral as a separate dispersant, and a balance of ethanol denatured with tert-butyl alcohol and denatonium benzoate (SDA 40B). The carbon black pigment had an average diameter of 100 nm. Example ink A also included polyvinyl butyral (having a weight-average molecular weight less than 20,000 Daltons) and REACTOL™ 1111E (4-t-butylphenol-formaldehyde resin having a weight-average molecular weight less than 10,000 Daltons available from Lawter, Inc.).

The general formulation of example ink A is shown in Table 2, with the wt % active of each component that was used. As such, the wt % for the pigment represents the solid pigment loading, and does not account for other components of the pigment dispersion.

TABLE 2

| | | Example |
|---|---|---|
| | | Ink |
| Ingredient | Specific Component | A |
| Pigment Dispersion | Black pigment dispersion (100 nm) | 2 |
| Resin | Polyvinyl butyral | 0.5 |
| | REACTOL ™ 1111E | 2 |
| Surfactant | FLUOROLINK ® A10P | 0.3 |
| Co-solvent | Ethyl acetate | 5 |
| Solvent | Ethanol denatured with tert- | Balance |
| | butanol and denatonium benzoate | |

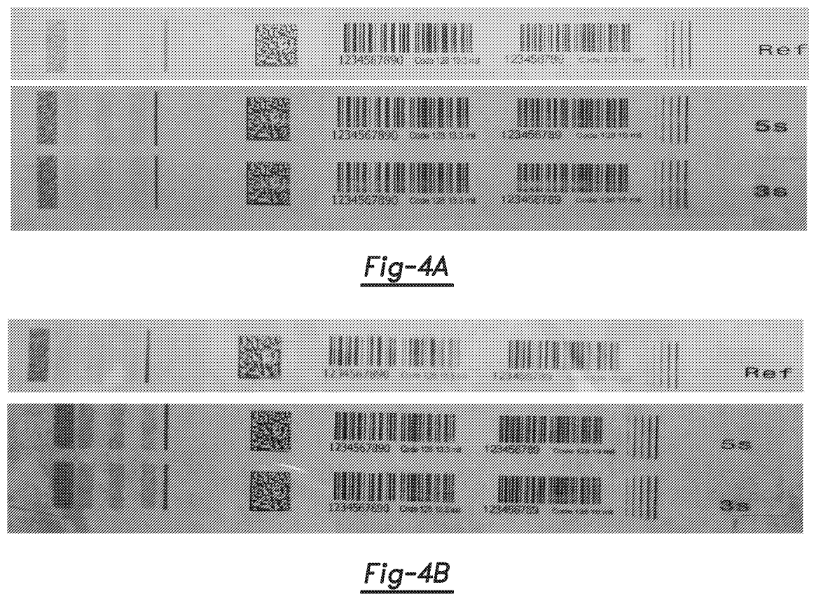

Example ink A was thermal inkjet printed on untreated biaxially-oriented polypropylene and on untreated low density polyethylene. Each print included a single row of blocks, a QR code, several barcodes, and several lines. One print was not exposed to a rub test (e.g., the reference print), and a rub test was performed across each other print. For the rub test, a certain amount of time was allowed to pass after a respective row was printed, and then a Sutherland rub tester was rubbed across the print from left to right across the row. Several rub tests were performed, including at 30 seconds dry time, 20 seconds dry time, 10 seconds, dry time, 7 seconds dry time, 5 seconds dry time, and 3 seconds dry time. The reference print and the prints exposed to the rub test at 5 seconds dry time and 3 seconds dry time are reproduced herein in FIGS. 4A and 4B. More particularly, FIG. 4A depicts the prints on untreated biaxially-oriented polypropylene, where the top row is the reference print (no rub), the middle row depicts the print exposed to the rub test 5 seconds after printing, and the bottom row depicts the print exposed to the rub test 3 seconds after printing; and FIG. 4B depicts the prints on untreated low density polyethylene, where the top row is the reference print (no rub), the middle row depicts the print exposed to the rub test 5 seconds after printing, and the bottom row depicts the print exposed to the rub test 3 seconds after printing. The respective dry time is indicated to the right of the rows exposed to the rub test. As shown in FIGS. 4A and 4B, the prints on both media types exhibited no spearing as a result of the rub test, whether it was performed at 3 seconds or at 5 seconds of dry time. The prints that were allowed to dry even longer are not shown, as these also exhibited no smearing. These results indicate that example ink A was dry after 3 seconds on both untreated biaxially-oriented polypropylene and untreated low density polyethylene. It is noted that the streak mark shown in FIG. 4A was a printing trajectory error, and was not a result of the rub test.

### Example 3

A durability test was performed using an example of the non-aqueous inkjet ink disclosed herein that did not include the resin package (referred to as Example ink B). The example inks without the resin package may be particularly suitable for printing on treated non-porous polymeric substrates.

In this example, example ink B was used, which had the same formulation as the second ink from Example 1. Example ink B was thermal inkjet printed on treated biaxially-oriented polypropylene to form two separate prints, and then the prints were exposed to a rub test to determine the percent fade, which is indicative of print durability.

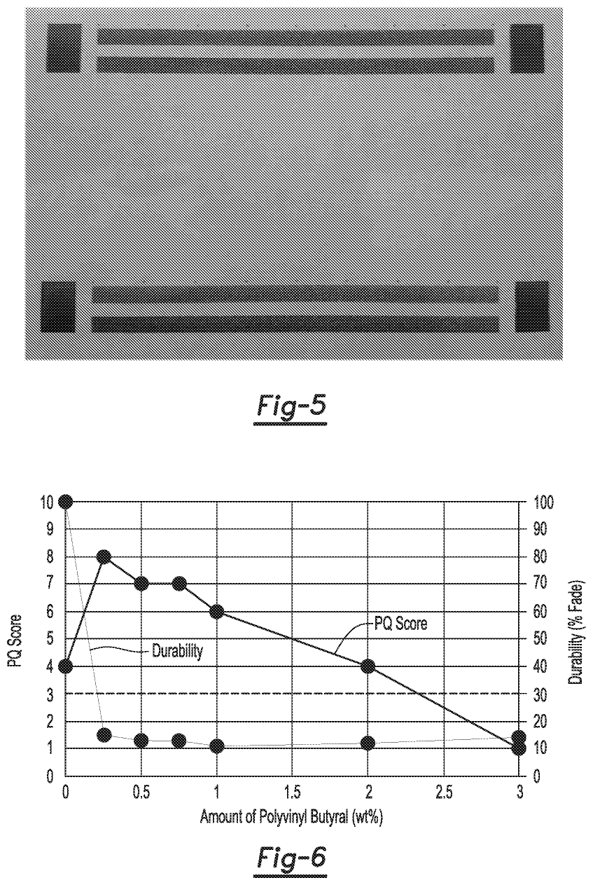

The percent fade was calculated using the optical density difference of portions of the prints (formed on the treated biaxially-oriented polypropylene film) exposed to the rub test and not exposed to the rub test. For the rub test, a rub-tester, TMI® (Testing Machines Inc., New York) model #10-1801-0001, was used, which was fitted with an eraser having one drop squalene oil applied at the tip. The various prints were rubbed 30 times in three spots at a pressure of 30 psi. The prints were then scanned using an EPSON® V5000 Office Scanner (Seiko Epson Corp., Japan), and the optical density at the rubbed and not rubbed locations was determine with the QEA IAS Lab version 3 software. The percent fade (indicative of durability and adhesion) for both prints was calculated by dividing the optical density difference of rubbed and not rubbed areas by the optical density of the areas that are not rubbed. A percent fade of 30% or less is desirable, indicating suitable durability and adhesion of the print. The example prints formed on the treated biaxially-oriented polypropylene film had a 13% fade, and thus exhibited exceptional durability. Moreover, it is believed that this percent fade may be within the noise of the rub test, because visually there were no signs of fading, as illustrated in FIG. 5. FIG. 5 depicts (in black and white) the prints on the treated biaxially-oriented polypropylene after the rub test had been performed. As shown, example ink B had good wetting, adhesion, and optical density on the treated biaxially-oriented polypropylene, even after the rub test.

### Example 4

A durability test was performed to determine the effect of polyvinyl butyral resin in two different pigment-based non-aqueous inkjet inks printed on untreated biaxially-oriented polypropylene and on untreated polyethylene terephthalate, and to compare the performance to a dye based ink printed on untreated biaxially-oriented polypropylene.

The formulations of the pigment- and dye-based inks are shown in Table 3, with the wt % active of each component that was used. As such, the wt % for the pigment represents the solid pigment loading, and does not account for other components of the pigment dispersion.

TABLE 3

| | | Pigment | Dye |
|---|---|---|---|
| Ingredient | Specific Component | Ink | Ink |
| Colorant | Black pigment dispersion of | 2 | 0 |
| | Example 1 | | |
| | Black and Orange Dye | 0 | 6.5 |
| | Combination | | |
| Resin | Polyvinyl butyral | 0.25 or 0.5 | 0 |
| Surfactant | FLUOROLINK ® A10P | 0.3 | 0.3 |
| Co-solvent | Ethyl acetate | 5 | 5 |
| Solvent | Ethanol denatured with tert- | Balance | Balance |
| | butanol and denatonium benzoate | | |

The pigment-based inks with different polyvinyl butyral loadings were thermal inkjet printed on untreated biaxially-oriented polypropylene to form two separate prints, and then the prints were exposed to the same rub test described in Example 3. The dye-based ink was also thermal inkjet printed on untreated biaxially-oriented polypropylene to form a print, and then the print was exposed to the same rub test described in Example 3. The percent fade was calculated, as described in Example 3, for the pigment-based prints and for the dye-based print. The average percent fade for the pigment-based prints on the biaxially-oriented polypropylene was 14%, while the percent fade of the dye-based print was 25%. These results indicate that adding small amounts of polyvinyl butyral to pigment-based inks can improve the adhesion of the ink to untreated biaxially-oriented polypropylene (when compared to a dye-based ink).

The pigment-based inks with different polyvinyl butyral loadings were also thermal inkjet printed on untreated polyethylene terephthalate to form two separate prints, and then the prints were exposed to the same rub test described in Example 3. The average percent fade for the pigment-based prints on the untreated polyethylene terephthalate was 13%.

A visual inspection of the prints formed with the pigment-based inks indicated little or no fade, thus indicating that the addition of the polyvinyl butyral improves the durability of the ink on treated non-porous polymeric substrates.

### Example 5

Several additional inks (1-7) were prepared to determine a suitable polyvinyl butyral resin level for the non-aqueous ink. Each of these inks had the same formulation except for the amount of polyvinyl butyral added. The different amounts of polyvinyl butyral added included 0 wt % (ink 1), 0.25 wt % (ink 2), 0.5 wt % (ink 3), 0.75 wt % (ink 4), 1 wt % (ink 5), 2 wt % (ink 6), and 3 wt % (ink 7), as shown in FIG. 6 (X-axis). The general formulation of each of these inks is shown in Table 4, with the wt % active of each component that was used. As such, the wt % for the pigment represents the solid pigment loading, and does not account for other components of the pigment dispersion.

TABLE 4

| Ingredient | Specific Component | Inks 1-7 |
|---|---|---|
| Pigment Dispersion | Black pigment dispersion (100 nm) | 2 |
| Resin | Polyvinyl butyral | 0-3 |
| Surfactant | FLUOROLINK ® A10P | 0.3 |
| Co-solvent | Ethyl acetate | 5 |
| Solvent | Ethanol denatured with tert-butanol | Balance |
| | and denatonium benzoate | |

Inks 1-7 were thermal inkjet printed on untreated biaxially-oriented polypropylene. The print quality and the durability were measured for each of the prints generated.

The print quality was visually assessed and was given a score from 0 to 10, where 0 indicated that the ink was non-jettable ink, and 10 indicated excellent print quality. The durability was measured in terms of percent fade of optical density after the rub test as described in Example 3 was performed. A percent fade of 30% or less indicated acceptable durability.

The results of the print quality assessment and durability measurements for each of inks 1-7 are shown in FIG. 6. In FIG. 6, the print quality (PQ) score is shown on the left Y-axis, the durability (in percent fade) is shown on the right Y-axis, and the ink used to generate the print is identified on the X-axis by the amount of polyvinyl butyral (in wt %) in the ink. The black dashed line represents the target fade line of 30%.

As shown in FIG. 6, the inks including 0.25 wt % polyvinyl butyral to 1 wt % polyvinyl butyral had both a print quality score of 6 or higher and a percent fade in optical density of less than 20%. It was discovered that as the polyvinyl butyral concentration exceeded 1%, the print quality deteriorated with no added gain in durability. Thus, examples of the ink disclosed herein that include the resin package may include from about 0.1 wt % up to 1 wt % of the polyvinyl butyral resin (noting that this percentage does not account for the minimal amount that may be introduced as part of the pigment dispersion).

It is to be understood that the ranges provided herein include the stated range and any value or sub-range within the stated range, as if such values or sub-ranges were explicitly recited. For example, from about 0.5 wt % up to 2.5 wt % should be interpreted to include not only the explicitly recited limits of from about 0.5 wt % up to 2.5 wt %, but also to include individual values, such as about 0.85 wt %, about 1.9 wt %, about 2.4 wt %, etc., and sub-ranges, such as from about 0.9 wt % to about 2.3 wt %, from about 1 wt % to about 2 wt %, from about 0.75 wt % to about 1.75 wt %, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A non-aqueous inkjet ink, comprising:
a phenol-formaldehyde resin, wherein the phenol-formaldehyde resin is a C₃ to C₈ alkyl-modified phenol-formaldehyde resin;
a polyvinyl butyral resin;
a pigment;
a perfluoropolyether surfactant, a hydroxythioether surfactant, or a combination thereof;
from about 2 wt % to about 10 wt % of a C₂ to C₆ ester solvent, based on a total weight of the non-aqueous inkjet ink; and
a balance of a C₁ to C₅ alcohol solvent.

2. The non-aqueous inkjet ink as defined in claim 1, wherein the C₂ to C₆ ester solvent is ethyl acetate present in an amount ranging from about 2 wt % to about 6 wt % of the total weight of the non-aqueous inkjet ink.

3. The non-aqueous inkjet ink as defined in claim 1 wherein the pigment is a non-self-dispersed pigment, and the non-aqueous inkjet ink further comprises a polymeric dispersant.

4. The non-aqueous inkjet ink as defined in claim 3, wherein:
the non-self-dispersed pigment is present in the non-aqueous inkjet ink in an amount up to 4 wt %, based on the total weight of the non-aqueous inkjet ink; and
the polymeric dispersant is present in the non-aqueous inkjet ink in an amount up to about 4% of the total weight of the non-aqueous inkjet ink.

5. The non-aqueous inkjet ink as defined in claim 1 wherein the phenol-formaldehyde resin is a 4-t-butylphenol-formaldehyde resin.

6. The non-aqueous inkjet ink as defined in claim 1 wherein a ratio of the polyvinyl butyral resin to the phenol-formaldehyde resin ranges from 1:10 to 1:1.5, and wherein a combined total of the polyvinyl butyral resin and the phenol-formaldehyde resin in the non-aqueous inkjet ink ranges from about 2 wt % active to about 3 wt % active, based on the total weight of the non-aqueous inkjet ink.

7. The non-aqueous inkjet ink as defined in claim 1 wherein the C₁ to C₅ alcohol solvent is ethanol denatured with tert-butanol and denatonium benzoate.

8. The non-aqueous inkjet ink as defined in claim 1 wherein the perfluoropolyether surfactant, the hydroxythioether surfactant, or the combination thereof is present in an amount ranging from about 0.25 wt % to about 0.35 wt % of the total weight of the non-aqueous inkjet ink.

9. The non-aqueous inkjet ink as defined in claim 1 wherein:
the polyvinyl butyral resin is present in an amount ranging from about 0.1 wt % up to 1 wt %, based on the total weight of the non-aqueous inkjet ink; and
the phenol-formaldehyde resin is present in an amount ranging from about 0.5 wt % up to 2.5 wt %, based on the total weight of the non-aqueous inkjet ink.

10. A non-aqueous inkjet ink, consisting of:
a non-self-dispersed pigment;
a polymeric dispersant;
from about 0.25 wt % to about 0.35 wt % of a perfluoropolyether surfactant, a hydroxythioether surfactant, or a combination thereof, based on a total weight of the non-aqueous inkjet ink;
from about 2 wt % to about 10 wt % of a C₂ to C₆ ester solvent, based on the total weight of the non-aqueous inkjet ink;
water in an amount less than 1 wt %, based on the total weight of the non-aqueous inkjet ink;
a balance of a C₁ to C₅ alcohol solvent; and
an optional resin package consisting of a C₃ to C₈ alkyl-modified phenol-formaldehyde resin and a polyvinyl butyral resin.

11. The non-aqueous inkjet ink as defined in claim 10 wherein:
the C₂ to C₆ ester solvent is ethyl acetate; and
the C₁ to C₅ alcohol solvent is ethanol denatured with tert-butanol and denatonium benzoate.

12. The non-aqueous inkjet ink as defined in claim 10 wherein:
the optional resin package is included in the non-aqueous inkjet ink;
a ratio of the polyvinyl butyral resin to the phenol-formaldehyde resin ranges from 1:10 to 1:1.5; and
a combined total of the polyvinyl butyral resin and the phenol-formaldehyde resin in the non-aqueous inkjet ink ranges from about 2 wt % active to about 3 wt % active, based on the total weight of the non-aqueous inkjet ink.

13. A method, comprising:
providing a baseline solvent package consisting of:
a perfluoropolyether surfactant, a hydroxythioether surfactant, or a combination thereof;
a C₂ to C₆ ester solvent; and
a C₁ to C₅ alcohol solvent; and
adding a pigment dispersion to the baseline solvent package to generate a non-aqueous inkjet ink containing up to 4 wt % of a non-self-dispersed pigment and up to 1 wt % of water, both based on a total weight of the non-aqueous inkjet ink, wherein the pigment dispersion includes:
the non-self-dispersed pigment;
a polymeric dispersant; and
a balance of a second C₁ to C₅ alcohol solvent.

14. The method as defined in claim 13, further comprising adding a resin package to the baseline solvent package, the resin package consisting of a C₃ to C₈ alkyl-modified phenol-formaldehyde resin and a polyvinyl butyral resin.

15. The method as defined in claim 13 wherein the non-aqueous inkjet ink includes:
from about 0.25 wt % to about 0.35 wt % of the perfluoropolyether surfactant, the hydroxythioether surfactant, or the combination thereof, based on the total weight of the non-aqueous inkjet ink; and
from about 2 wt % to about 10 wt % of a C₂ to C₆ ester solvent, based on the total weight of the non-aqueous inkjet ink.
